(19) United States
(12) Patent Application Publication
(10) Pub. No.: US 2005/0267886 A1
(43) Pub. Date: Dec. 1, 2005

(54) Processing of tag data

(76) Inventors: Ian Anthony Pepper, Dublin (IE); Austin Cagney, Dublin (IE)

Correspondence Address: JACOBSON HOLMAN PLLC, 400 SEVENTH STREET N.W., SUITE 600, WASHINGTON, DC, 20004, US

(21) Appl. No.: 11/203,186

(22) Filed: Aug. 15, 2005

Related U.S. Application Data
(63) Continuation-in-part of application No. 10/141,337, filed on May 9, 2002.
(60) Provisional application No. 60/601,149, filed on Aug. 13, 2004.

(51) Int. Cl. G06F 7/00

(52) U.S. Cl. 707/8

(57) ABSTRACT

RFID tag data is stored as a tag object in a hierarchical database structure. Date/Time/periods of higher levels of granularity are encoded integrally in the database structure, avoiding need for an index for such time periods. The database controller identifies a relevant tag object and then drills down through relevant year, day and hour nodes to arrive at an observation at a leaf node. The observations are stored as objects having the relevant data values and the time periods of lowest granularity.

This application is a Continuation-in-Part of U.S. patent application Ser. No. 10/141,337 dated May 9, 2002.

### INTRODUCTION

1. Field of the Invention

The invention relates to processing and storage of data read from tags such as radio frequency identification (RFID) tags.

2. Prior Art Discussion

RFID tags are simple hardware devices which respond to an electromagnetic source from an RFID reader device to provide identification data. The read data is processed by adding a time stamp and location data and the whole data “Observation” is stored in a database for use in track and trace applications such as supply chain management. RFID tags offer an alternative to the line-of-sight barcode technology in common use today.

At present, there are two major obstacles to more widespread use of RFID tagging, namely the cost of the tags themselves, and the problem of how to handle the huge volumes of data involved. This invention addresses the latter problem.

### SUMMARY OF THE INVENTION

According to the invention, there is provided a method of processing tag observation data including a time stamp and an observation, the method comprising the steps of:
identifying time periods of the timestamp;
a database controller encoding a time-based structure of a database with at least one of the time periods of the time stamp so that said time-based structure is an integral index; and
storing the observation in a value level of the database which is accessed by traversing through the time-based structure according to the time stamp.

In one embodiment, the time-based structure comprises hierarchical levels of time periods of the time stamp, each lower level defining a shorter time period of the time stamp than an upper level.

In another embodiment, the database controller performs a database query by using an historical or current searching time to traverse through the time-based structure to reach the value level, and reading an observation from a part of the value level accessed by said traversal.

In a further embodiment, comprises the step of storing in the database a discrete tag object for each tag.

In one embodiment, comprises the step of storing in the database a discrete tag object for each tag; and wherein tag object identifiers are stored at a database level above the time-based structure.

In another embodiment, comprises the step of storing in the database a discrete tag object for each tag; and wherein tag identifier data is stored as an attribute object of the tag object.

In a further embodiment, comprises the step of storing in the database a discrete tag object for each tag; and wherein tag identifier data is stored as an attribute object of the tag object; and wherein an attribute is stored as an attribute ID value pair.

In one embodiment, comprises the step of storing in the database a discrete tag object for each tag; and wherein all observations for a tag are stored in database levels below that of the object for said tag.

In another embodiment, comprises the step of storing in the database a discrete tag object for each tag; and wherein data concerning an organization is stored in the database, and wherein the tag objects are located at a level below the organization data.

In a further embodiment, the organization data is stored as organization objects, and the database controller maintains a look-up table mapping the organization objects.

In one embodiment, the organization data is stored as organization objects; and wherein the controller links a plurality of databases by generating a linked list of organization objects.

In another embodiment, observations are stored as observation objects.

In a further embodiment, observations are stored as observation objects; and wherein the observation objects are grouped under an observation array database structure level.

In one embodiment, observations are stored as observation objects; and wherein the observation objects are grouped under an observation array database structure level; and wherein an observation array holds a database disk page.

In another embodiment, comprises the further steps of filtering out tag mis-reads.

In a further embodiment, comprises the further steps of performing data aggregation and routing of tag data to at least one of a plurality of application servers.

In another aspect, the invention provides a method of performing a write of tag observation data to a database, the method comprising the steps of:
locating a database node for the tag;
traversing nodes of a time-based database structure below that of the tag node using at least part of an observation time stamp, in which nodes for time periods of the time value of successively smaller granularity are traversed; and
writing the observation at a leaf node at the end of the path traversed through the database.

In one embodiment, the observation is written as an observation object having observation data attributes.

In another embodiment, the observation includes a time value at a smaller level of granularity than that of the lowest database time-encoded node.

In a further aspect, the invention provides a method of performing a read of a tag observation from a database, the method comprising the steps of:
locating a database node for the tag;
traversing nodes of a time-based database structure below that of the tag node using a searching time value, in which nodes for time periods of the searching time value of successively smaller granularity are traversed; and
reading data from an observation located at a leaf node at the end of the path traversed through the database.

In one embodiment, time periods of lowest granularity are stored with the observation, and the method comprises the steps of reading time values of a plurality of observations to identify that required.

In another embodiment, time periods of lowest granularity are stored with the observation, and the method comprises the steps of reading time values of a plurality of observations to identify that required; and wherein the read is for a range of searching time values and the method comprises the step of reading all observations which have lowest granularity level time values within the range.

The invention also provides systems to perform any of the methods defined above.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1 is a diagrammatic representation of a data capture and storage system; and

FIG. 2 is a UML database scheme for storage of the data.

### DESCRIPTION OF THE EMBODIMENTS

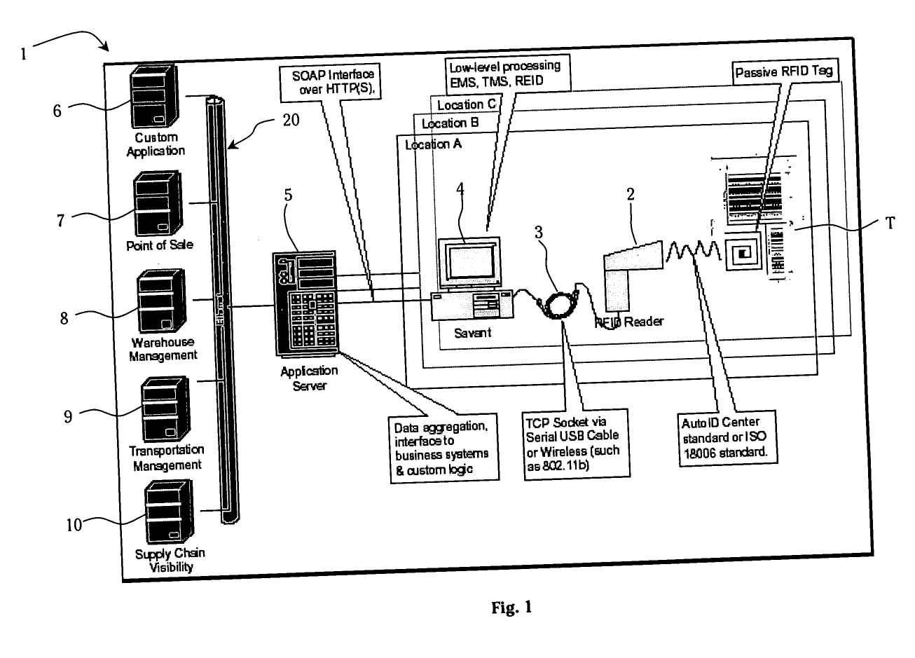

Referring to FIG. 1 an RFID tag T is attached to an item in a supply chain location such as a warehouse. An RFID reader 2 captures data from the tag T according to the AUTO ID Centre standard, or the ISO 18006 standard. The manner in which data is captured from the tag, and the construction of the tag itself are known in the art and are not the subject of this invention.

The data is fed on a TCP socket via a Serial USB cable 3, or alternatively a wireless link to a Savant™ system 4. The system 4 performs low level data management to filter out for example RFID tag misreads. The system 4 feeds the application server 5 connected to the system 4 and performs data aggregation operations and interfaces to business systems 6-10 via a network 20. The business systems include in this example:
a custom application server 6,
a point of sale system 7,
a warehouse management system 8,
a transportation management system 9, and
a supply chain visibility system 10.

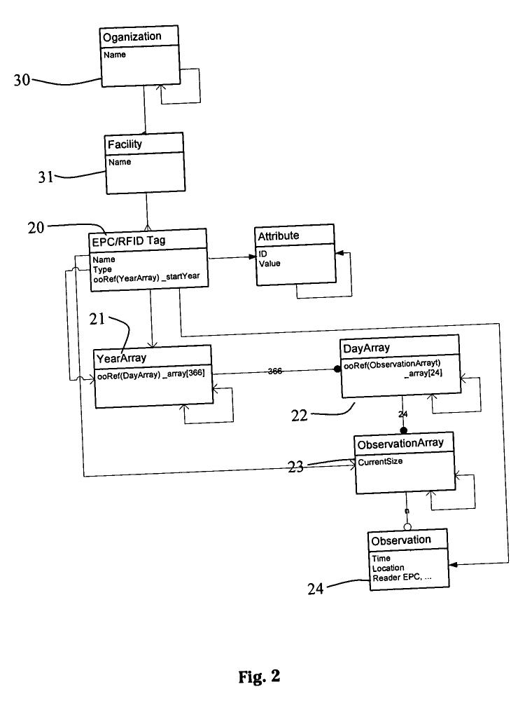

The application server 5 manages the data storage according to a UML (Universal Modelling Language) schema shown in FIG. 2. The tag observation data which is read includes a time stamp and an observation. In the model of FIG. 2 hierarchical decomposition has been used for highly efficient writes and reads of large volumes of tag observations. The database structure has various levels and the database controller traverses through nodes in the levels to reach the observation (or “value”) level. Each RFID tag is represented by a discrete object 20 (EPC/RFID Tag) in the database. Associated with each tag are a number of intermediate data structures 21 and 22 which break down the date and time of an observation into the year (YearArray), day (DayArray) and then down to the hour level. This is a time-based structure providing an integral index.

As observations are small (typically <20 bytes) they are organized into arrays 23 to minimise storage space in an ObservationArray object. An ObseravtionArray object 23 is sized such that it holds enough Observation objects 24 to fill a database (disk) page. At the leaf level of the database the actual Observation objects themselves are stored. The DayArray has 22 slots each of which corresponds to a one hour time period.

Above the EPC/RFID Tag object are two organizational objects which allow the EPC/RFID Tag space to be partitioned according to the Auto-ID and ISO 18006 standards. At the top level is a list of Organization objects 30, and each Organization object may be linked to multiple Facility objects 31, which in turn are linked to multiple EPC/RFID Tag objects 20. To link multiple databases together a linked list of Organization objects 30 is employed.

The combination of Organization and Facility objects 30 and 31 and the structure thereof is very advantageous when dealing with many (billions) of EPC/RFID Tag objects and Observation objects as may be found in a large RFID deployment. This structure partitions the namespace of the EPC/RFID data into manageable chunks. In turn, the EPC/RFID Tags may be uniquely identified and addressed (looked up) in the database quickly, as each set associated with a Facility object 31 is a member of a database look up table (or map). Thus, given the ID of the EPC/RFID Tag it may be instantly retrieved from the map. An RFID tag may have associated attributes such as Expiry Date or Maximum Temperature Value for medicines. These attributes are stored in a list of Attribute objects attached to the EPC/RFID Tag object. Each Attribute is stored as an attribute ID Value pair.

With this model two important queries may be very quickly executed by simply traversing a few objects in the database. The genealogy query “Where has it been?”, becomes simply locating the start time of the query in the object structure and traversing until the end time is reached by checking the Time attribute of each Observation object. The query “Where is it now?” becomes very simply the last Observation for the item. A pointer to the last Observation is stored in the database so that this object can be located very quickly. This is very advantageous.

Thus, the first levels are time-encoded so that indexing is avoided. The processor simply drills down according to the relevant time (either current or previous) to retrieve the observation. The observation data for each tag is stored as an object.

The Observation objects store the data from each read of the RFID Tag, and include the Time of the read operation, the Location of the read operation and the Electronic Product Code (EPC) of the reader device. Additional data may also be stored, depending on the RFID application. For example, if the RFID tagged items are perishable goods then the Temperature at the time of the read operation may also be stored as part of the Observation object.

It will be appreciated that the invention provides for highly efficient storage of the huge volumes of data which are involved for on-going capture of supply chain data from RFID tags. Because part of the time stamp of each observation is inherently encoded in the database structure there is no need to store this part of the time stamp (in the above embodiment year, day, and hour). Traversal through the database to perform reads and writes is very efficient because of the speed with which hourly time periods can be isolated. Of course, these periods can be different depending on the expected volumes and frequency of data and the available storage resources.

The invention is not limited to the embodiments described but may be varied in construction and detail. For example, it may be applied to storage of data from other types of tags such as bar-coded tags.

1. A method of processing tag observation data including a time stamp and an observation, the method comprising the steps of:
identifying time periods of the timestamp;
a database controller encoding a time-based structure of a database with at least one of the time periods of the time stamp so that said time-based structure is an integral index; and
storing the observation in a value level of the database which is accessed by traversing through the time-based structure according to the time stamp.

2. A method of processing tag data as claimed in claim 1, wherein the time-based structure comprises hierarchical levels of time periods of the time stamp, each lower level defining a shorter time period of the time stamp than an upper level.

3. A method of processing tag data as claimed in claim 1, wherein the database controller performs a database query by using an historical or current searching time to traverse through the time-based structure to reach the value level, and reading an observation from a part of the value level accessed by said traversal.

4. A method of processing tag data as claimed in claim 1, comprising the step of storing in the database a discrete tag object for each tag.

5. A method of processing tag data as claimed in claim 1, comprising the step of storing in the database a discrete tag object for each tag; and wherein tag object identifiers are stored at a database level above the time-based structure.

6. A method of processing tag data as claimed in claim 1, comprising the step of storing in the database a discrete tag object for each tag; and wherein tag identifier data is stored as an attribute object of the tag object.

7. A method of processing tag data as claimed in claim 1, comprising the step of storing in the database a discrete tag object for each tag; and wherein tag identifier data is stored as an attribute object of the tag object; and wherein an attribute is stored as an attribute ID value pair.

8. A method of processing tag data as claimed in claim 1, comprising the step of storing in the database a discrete tag object for each tag; and wherein all observations for a tag are stored in database levels below that of the object for said tag.

9. A method of processing tag data as claimed in claim 1, comprising the step of storing in the database a discrete tag object for each tag; and wherein data concerning an organization is stored in the database, and wherein the tag objects are located at a level below the organization data.

10. A method of processing tag data as claimed in claim 9, wherein the organization data is stored as organization objects, and the database controller maintains a look-up table mapping the organization objects.

11. A method of processing tag data as claimed in claim 9, wherein the organization data is stored as organization objects; and wherein the controller links a plurality of databases by generating a linked list of organization objects.

12. A method of processing tag data as claimed in claim 1, wherein observations are stored as observation objects.

13. A method of processing tag data as claimed in claim 1, wherein observations are stored as observation objects; and wherein the observation objects are grouped under an observation array database structure level.

14. A method of processing tag data as claimed in claim 1, wherein observations are stored as observation objects; and wherein the observation objects are grouped under an observation array database structure level; and wherein an observation array holds a database disk page.

15. A method of processing tag data as claimed in claim 1, comprising the further steps of filtering out tag mis-reads.

16. A method of processing tag data as claimed in claim 1, comprising the further steps of performing data aggregation and routing of tag data to at least one of a plurality of application servers.

17. A method of performing a write of tag observation data to a database, the method comprising the steps of:
locating a database node for the tag;
traversing nodes of a time-based database structure below that of the tag node using at least part of an observation time stamp, in which nodes for time periods of the time value of successively smaller granularity are traversed; and
writing the observation at a leaf node at the end of the path traversed through the database.

18. A method as claimed in claim 17, wherein the observation is written as an observation object having observation data attributes.

19. A method as claimed in claim 17, wherein the observation includes a time value at a smaller level of granularity than that of the lowest database time-encoded node.

20. A method of performing a read of a tag observation from a database, the method comprising the steps of:
locating a database node for the tag;
traversing nodes of a time-based database structure below that of the tag node using a searching time value, in which nodes for time periods of the searching time value of successively smaller granularity are traversed; and
reading data from an observation located at a leaf node at the end of the path traversed through the database.

21. A method as claimed in 20, wherein time periods of lowest granularity are stored with the observation, and the method comprises the steps of reading time values of a plurality of observations to identify that required.

22. A method as claimed in claim 20, wherein time periods of lowest granularity are stored with the observation, and the method comprises the steps of reading time values of a plurality of observations to identify that required; and wherein the read is for a range of searching time values and the method comprises the step of reading all observations which have lowest granularity level time values within the range.

23. A database system comprising a storage device, an interface to receive tag observation data including an observation and a time stamp, and a database controller for:
identifying time periods of the timestamp;
encoding a time-based structure of a database with at least one of the time periods of the time stamp so that said time-based structure is an integral index; and
storing the observation in a value level of the database which is accessed by traversing through the time-based structure according to the time stamp.

24. A database system comprising a storage device, an interface to receive tag observation data including an observation and a time stamp, and a database controller for:
locating a database node for the tag;
traversing nodes of the database below that of the tag node using at least part of an observation time stamp, in which nodes for time periods of the time value of successively smaller granularity are traversed; and
writing the observation at a leaf node at the end of the path traversed through the database.

25. A database system comprising a storage device, an interface to receive tag observation data including an observation and a time stamp, and a database controller for:
locating a database node for the tag;
traversing nodes of a time-based database structure below that of the tag node using a searching time value, in which nodes for time periods of the searching time value of successively smaller granularity are traversed; and
reading data from an observation located at a leaf node at the end of the path traversed through the database.
